(19) United States
(12) Patent Application Publication
(10) Pub. No.: US 2004/0238558 A1
(43) Pub. Date: Dec. 2, 2004

(54) Device for Connecting Ends of Bars

(75) Inventor: Klaus Frohlich, Pforzheim (DE)

Correspondence Address: GUDRUN E. HUCKETT DRAUDT, LONSSTR. 53, WUPPERTAL, 42289, DE

(73) Assignee: HALFEN GMBH + CO. KOMMANDITGESELLSCHAFT, Langenfeld-Richrath (DE)

(21) Appl. No.: 10/709,513

(22) Filed: May 11, 2004

(30) Foreign Application Priority Data
May 26, 2003 (EP) 03011801.2

(51) Int. Cl. A44B 21/00; A44B 11/25; A44B 1/04; B65G 59/00; B65H 3/00; G07F 11/16; A41F 1/00; B23Q 7/04; A44B 17/00; B42F 1/00

(52) U.S. Cl. 221/210

(57) ABSTRACT

A device for connecting bar ends has a pipe section into which the rods to be connected are inserted with their ends. Several clamping elements each having an outer thread are provided that can be secured in threaded bores of the pipe section by being screwed in. The clamping elements are arranged in two rows and are positioned, relative to the circumference of the pipe section, on the same side of the pipe section. The clamping elements are staggered relative to one another.

### BACKGROUND OF INVENTION

The invention relates to a device for connecting bar ends, in particular, of reinforcement bars in concrete construction, comprising a pipe section into which the bars to be connected are inserted with their ends, and comprising several clamping elements each having an outer thread that are secured in threaded bores of the pipe section by being screwed in.

U.S. Pat. No. 5,046,878 discloses a connecting device for producing connections of reinforcement bars for concrete construction. This connecting device is comprised of a sleeve into which the bar ends are inserted. The sleeve has several radial threaded bores into which screws are screwed by which a corresponding clamping force is applied to the bar ends. On the side opposite to the screws, an elongate insertion member is provided between the sleeve and the bar ends; this insertion member has transverse ribs and is supposed to increase the mechanical strength of the connection.

In the known device, the insertion member provided with the ribs is inserted upon producing the connection of the bar ends, i.e., when connecting the bar ends by means of the sleeve, the insertion member must be available; this insertion member must be sized to fit the corresponding sleeve cross-section or diameter of the bar ends. When accidentally mixing up the parts, i.e., when the parts are not matched to the appropriate required size, assembly mistakes can occur so that the required strength is not achieved.

### SUMMARY OF INVENTION

The present invention has therefore the object to provide a device of the aforementioned kind for connecting bar ends that can be handled more easily and that does not require the insertion of additional parts at the construction site.

This object is solved by a device for connecting bar ends in that two rows of clamping elements are positioned, relative to the circumference of the pipe section, on the same side of the pipe section and are staggered relative to one another relative to the longitudinal direction of the pipe section.

Because of the staggered arrangement of the clamping elements in two rows, it is possible to arrange the clamping elements sequentially more tightly to one another so that a greater clamping force can be applied and, in this way, the length of the pipe section can be smaller. When arranging the clamping elements in two staggered rows relative to one another, this also provides that, relative to the circumference of the bar ends, the forces act at three location on the bar ends, i.e., by means of the two rows of screws and, as a third force, by means of the abutment that is provided by the wall of the pipe section that is essentially positioned diametrically opposed to the clamping elements.

According to a preferred embodiment, it is provided that the ends of the clamping elements facing the bars act in different directions onto the bars. It is expedient in this connection that the longitudinal axes of the threaded bores and clamping elements of a first row are arranged at an angle relative to the longitudinal axes of the threaded bores and clamping elements of the second row, wherein the angle is ≦60 degrees. It is considered to be particularly expedient that the angle is approximately 30 degrees because, in this way, a simple accessibility from the same side is provided so that mounting is facilitated.

According to an alternative configuration, the longitudinal axes of the threaded bores and clamping elements of a first row are positioned at least approximately parallel to the longitudinal axes of the threaded bores and clamping elements of the second row, wherein the longitudinal axes, respectively, are positioned in a plane laterally displaced to the diameter of the pipe section. In this connection, it is expedient that a longitudinal edge of the threaded bores is at least positioned approximately on a tangent to the inner wall surface of the pipe section. In this way, the clamping elements are displaced maximally relative to one another.

In order to fix the insertion depth of each bar end, it is expedient that at least approximately at the center of the length of the pipe section a transverse element is arranged wherein this transverse element is a clamping pin that preferably diametrically penetrates the pipe section. For further increasing mechanical strength of the connection, it is advantageous that in each one of the sections of the pipe section that receives a bar end at least one clamping screw is provided that, relative to the circumference of the pipe section, is positioned substantially diametrically opposed to the clamping means of the two rows.

According to another advantageous embodiment, it is provided that transverse pins are arranged near the inner wall of the pipe section so that the bar end is supported at this location while a radial deformation is realized in the neighboring areas by means of the next clamping element, respectively. In this way, an increased strength results because of the deformation of the bar ends and the effected increased positive engagement. In the case of devices with transverse pins near the inner wall of the pipe section, it is expedient that the longitudinal axis of a clamping element intersects at least approximately the transverse pin and that the longitudinal axis of another clamping element is positioned at a spacing relative to the transverse pin, wherein the spacing is approximately twice the diameter of the clamping element. In this way, a sufficient spacing is provided that enables deformation of the bar end in an area laterally adjacent to the transverse pin. The transverse pin is preferably a clamping pin or grooved pin and is comprised of a material having a strength that is greater than that of the reinforcement bar.

### BRIEF DESCRIPTION OF DRAWINGS

FIG. 1 shows a device for connecting bar ends.

FIG. 2 is a view in the direction of arrow 11 in FIG. 1.

FIG. 3 is a plan view according to arrow III of FIG. 1.

FIG. 4 shows an embodiment variant of FIG. 1, shown without inserted bar ends.

FIG. 5 shows an embodiment variant to FIG. 2 with a clamping element arrangement according to FIG. 4.

FIG. 6 is a plan view onto the arrangement according to FIG. 4.

FIG. 7 is a further embodiment variant of FIG. 1 with additional clamping screws.

FIG. 8 shows an end view of the connecting arrangement of FIG. 7 with clamped bar end.

FIG. 9 is a view in the direction of arrow IX of FIG. 7.

FIG. 10 is a clamping screw shown as an individual part.

FIG. 11 shows a transverse element embodied as a clamping pin illustrating its longitudinal extension at the top and an end view at the bottom.

FIG. 12 shows a further embodiment of a connecting arrangement in longitudinal section.

FIG. 13 is an end view of the connecting arrangement according to FIG. 12.

### DETAILED DESCRIPTION

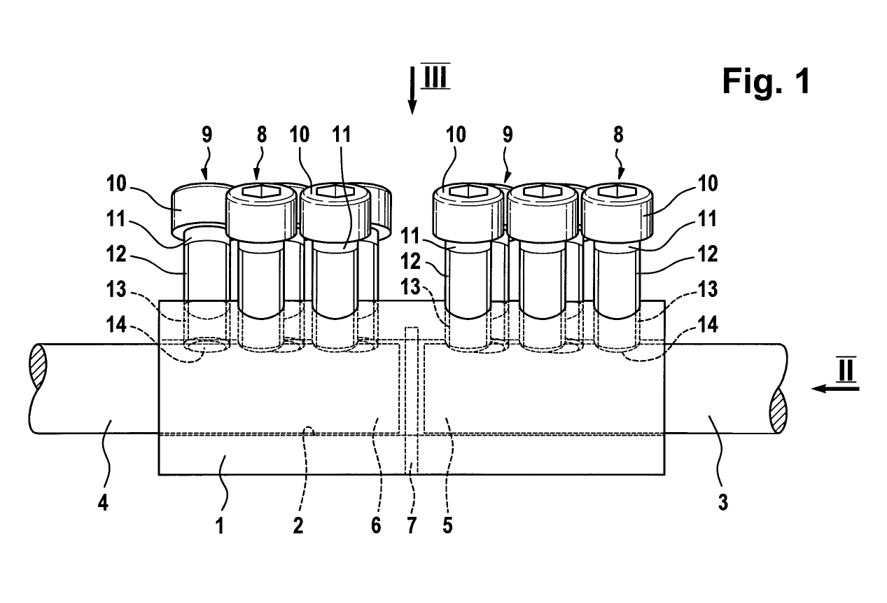

FIG. 1 shows a device for connecting bar ends, wherein this device comprises a pipe section 1 having a longitudinal opening 2 in which bar ends 5, 6 of reinforcement bars 3, 4 are received. Relative to the longitudinal extension of the pipe section 1, a transverse element 7 is arranged at the center of the pipe section that is preferably embodied as a clamping pin. By means of this clamping pin 7, the insertion depth of each bar end 5, 6 is defined. In the wall of the pipe section 1, several threaded bores 13 are provided which serve for receiving clamping elements 8, 9. The clamping elements 8, 9 comprise a screw head 10 as well as a shaft 11 with an outer thread 12 so that the clamping elements can be screwed into and secured in the threaded bores 13. When threading the clamping elements 8, 9 into the bores, the required clamping force acts on the bar ends 5, 6 by means of the ends 14 facing the bar ends 5, 6 in order to secure the bar ends 5, 6 safely within the pipe section 1.

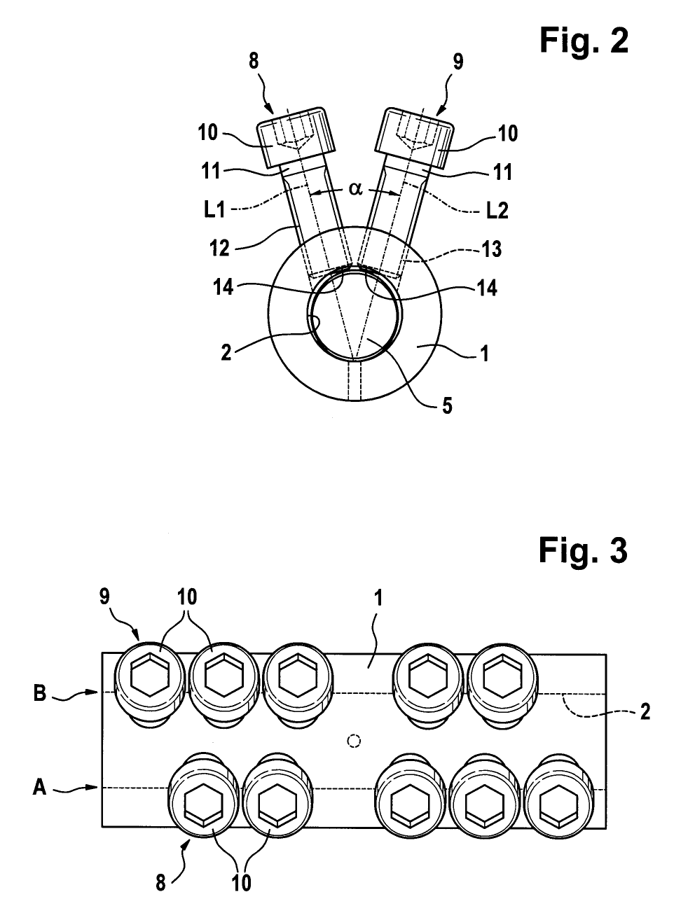

FIG. 2 shows an end view of the device wherein it can be seen that the clamping elements 8, 9 extend in a V-shape relative to one another with regard to the longitudinal axes L1 and L2. In the illustrated embodiment, the longitudinal axes L1 and L2 define an angle α (of 30 degrees between one another. Moreover, FIG. 2 shows that the reinforcement bar 3 or its bar end is clamped against the lower wall of the longitudinal opening 2 in the pipe section 1 as a result of the clamping force that is applied by the ends 14 of the clamping elements 8 and 9 onto the upper side of the bar end 5 as shown in FIG. 2. The reference numerals in FIG. 2 are identical to those of FIG. 1 for identical parts.

The plan view of FIG. 3 shows that the clamping elements 8 are arranged sequentially in a row A and aligned with one another; the clamping elements 9 are aligned sequentially in a different row B. As is also shown in FIG. 3, the clamping elements 8 are displaced relative to the clamping elements 9 so that, relative to the longitudinal extension of the bar ends 5, 6, the ends 14 of the clamping elements 8 and 9 illustrated in FIG. 2 act at different locations on the bar ends 5, 6.

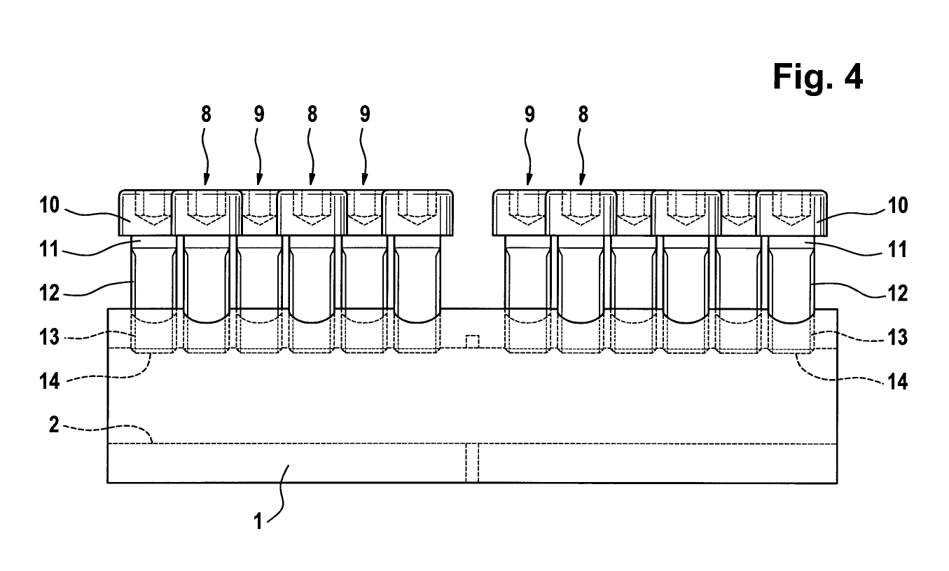

Another embodiment of the device for connecting bar ends is illustrated in FIG. 4, wherein this illustration does not show the inserted bar ends. FIG. 4 shows in connection with the plan view of FIG. 6 that the clamping elements 8, 9 are also arranged in rows A and B wherein the clamping elements 8 in the row A are staggered relative to the clamping elements 9 in the row B so that a clamping element 8 is positioned between two clamping elements 9, respectively, and vice versa.

FIG. 5 illustrates that the clamping element 8 and 9 are arranged such that their longitudinal axes L3 and L4 are parallel to one another. The longitudinal axes L3 and L4 therefore intersect at a right angle a common tangent of the longitudinal opening 2 or of the bar ends 5. The reference numerals in FIG. 5 are the same as in the afore described Figures for same parts. Moreover, FIG. 5 shows that the threaded bores 13 are arranged such that their longitudinal edges extend tangentially to the longitudinal opening 2 in the pipe section 1.

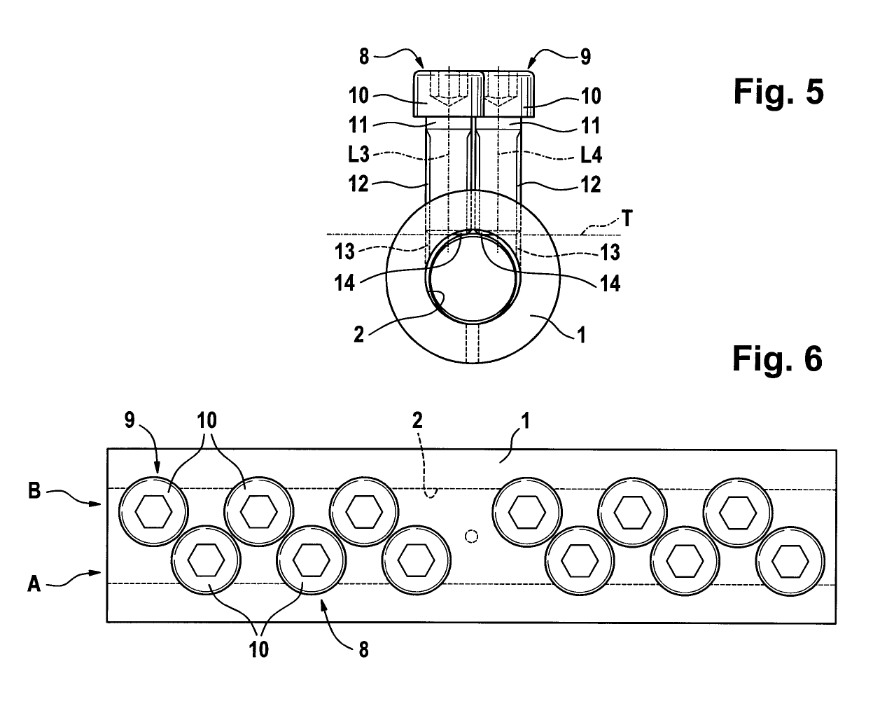

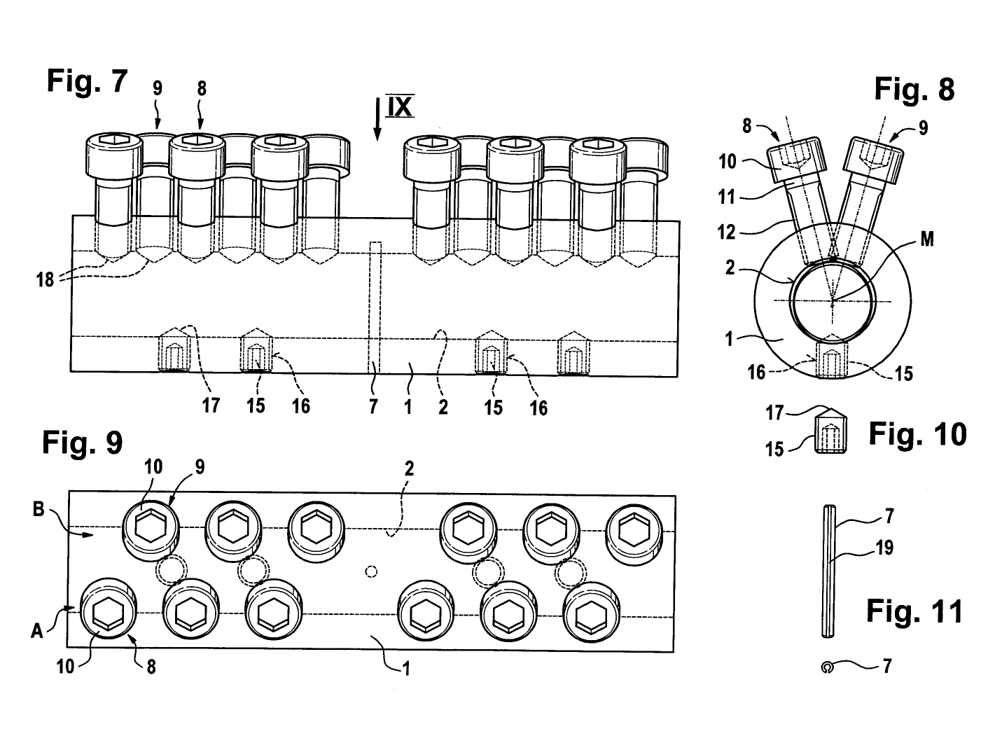

FIG. 7 shows a further embodiment variant of FIG. 1, wherein the difference resides in that the longitudinal axes L1 and L2 do not intersect one another at the opposed inner wall of the longitudinal opening 2 but at the center point M of the longitudinal opening. In this way, the clamping elements 8, 9 are arranged closer to one another as is illustrated in the plan view of FIG. 9. A further difference of the embodiments of FIGS. 7 and 8 resides in the clamping screws 15 that are inserted into the threaded bores 16 wherein these clamping screws 15 are positioned opposite the clamping elements 8, 9.

The clamping elements 8, 9 of the illustrated embodiment of FIGS. 7 and 8 have a tip 18 at the end of the shaft 11 so that a penetration into the material of the bar end is facilitated during clamping of the clamping elements 8, 9. The clamping screws 15 also have a tip 17, as shown in FIG. 10, so that also at this side a penetration into the material of the bar end is realized; in this way, the mechanical strength is further increased because of the positive engagement. FIG. 11 shows the transverse element 7 as an individual part wherein in the illustrated embodiment the transverse element is embodied as a clamping pin that has a longitudinal groove 19. In FIG. 11, the clamping pin is illustrated to show its longitudinal extension as well as an end view.

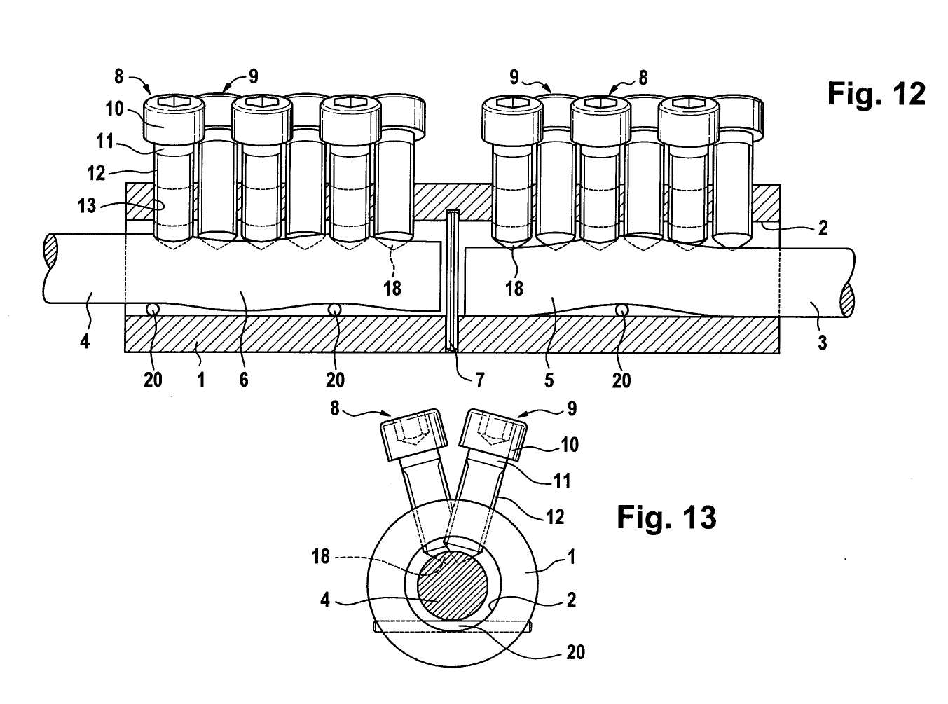

A further embodiment of a connecting arrangement for the ends of reinforcement bars is illustrated in FIG. 12. This embodiment also comprises a pipe section 1 with longitudinal opening 2 provided therein for receiving reinforcement bars 3, 4 or their bar ends 5, 6. As illustrated in FIGS. 12 and 13, in the pipe section 1 in immediate vicinity of the pipe wall the longitudinal opening 2 is provided with several transverse pins 20 that, in an advantageous embodiment, are also embodied as clamping pins 20 or groove pins.

On the side of the pipe section 1 opposite the clamping pins 20 the clamping elements 8, 9 are provided. At least some of the clamping elements 8, 9 are arranged such that they act on a section of the bar ends 5, 6 that is positioned adjacent to the clamping pin 20. For inserting the bar ends 5, 6, the clamping elements 8, 9 are in a position in which only the tip 18 on the shaft 11 projects into the longitudinal opening 2 so that between the tips 18 and the clamping pins 20 a sufficient spacing for introducing the bar ends 5, 6 is provided. By tightening the clamping elements 8, 9, the tips 18 of the clamping elements act on the bar ends 5, 6 wherein the clamping pins 20 acts as an abutment for supporting in this area the bar ends. By tightening the clamping elements 8, 9, a deformation of the bar ends 5, 6 takes place in the areas adjacent to the clamping pins 20 that also leads to an increase of the mechanical strength of the connecting arrangement. As in the afore described embodiments, a transverse element 7 is provided in FIG. 12 for fixing the insertion depth. The arrangement of the clamping elements 8, 9 corresponds to that shown in FIGS. 7 and 8.

What is claimed is:

1. A device for connecting bar ends, the device comprising:
a pipe section for receiving bars ends of bars to be connected;
clamping elements each having an outer thread;
wherein the pipe section has threaded bores in which the clamping elements are secured by being screwed in;
wherein the clamping elements are arranged in a first row and a second row on the same side of the pipe section relative to a circumference of the pipe section;
wherein the clamping elements of the first row are staggered relative to the clamping elements of the second row in a longitudinal direction of the pipe section.

2. The device according to claim 1, wherein the clamping elements have ends facing the bar ends and wherein the ends of the clamping elements act in different directions onto the bar ends.

3. The device according to claim 1, wherein the threaded bores and the clamping elements of the first row have first longitudinal axes and wherein the threaded bores and the clamping elements of the second row have second longitudinal axes, wherein the first and second longitudinal axes are arranged at an angle (α) of ≦60 degrees relative to one another.

4. The device according to claim 3, wherein the angle (α) is approximately 30 degrees.

5. The device according to claim 1, wherein the threaded bores and the clamping elements of the first row have first longitudinal axes and wherein the threaded bores and the clamping elements of the second row have second longitudinal axes, wherein the first and second longitudinal axes are at least approximately parallel to one another and are positioned in a plane laterally displaced relative to a diameter of the pipe section, respectively.

6. The device according to claim 1, wherein a longitudinal edge of the threaded bores is positioned at least approximately on a tangent of an inner pipe wall surface of the pipe section.

7. The device according to claim 1, wherein the clamping elements of the first row each are positioned between two of the clamping elements of the second row, respectively.

8. The device according to claim 1, further comprising a transverse element, arranged at least approximately at a longitudinal center of the pipe section.

9. The device according to claim 8, wherein the transverse element projects diametrically through the pipe section and is a clamping pin or a groove pin.

10. The device according to claim 1, wherein each section of the pipe section that receives a bar end has at least one clamping screw that, relative to the circumference of the pipe section, is positioned essentially opposite the clamping elements of the first and second rows.

11. The device according to claim 1, wherein each section of the pipe section that receives a bar end has at least one transverse pin that extends at least approximately at a right angle to a longitudinal axis of the pipe section and is arranged in immediate vicinity of an inner pipe wall.

12. The device according to claim 11, wherein the at least one transverse pin is a groove pin or a clamping pin and is comprised of hardened material.

13. The device according to claim 1, wherein the bars to be connected are reinforcement bars used in concrete construction.
